(19) United States
(12) Patent Application Publication
(10) Pub. No.: US 2025/0183512 A1
(43) Pub. Date: Jun. 5, 2025

(54) BASE STATION AND METHOD OF EMITTING RADIO WAVES

(71) Applicants: NEC Corporation, Minato-ku, Tokyo (JP); NEC Platforms, Ltd., Kawasaki-shi, Kanagawa (JP)

(72) Inventor: Keisuke YOKOYAMA, Kanagawa (JP)

(73) Assignees: NEC Corporation, Minato-ku, Tokyo (JP); NEC Platforms, Ltd., Kawasaki-shi, Kanagawa (JP)

(21) Appl. No.: 18/843,770

(22) PCT Filed: Mar. 18, 2022
(86) PCT No.: PCT/JP2022/012829

§ 371 Date: Sep. 4, 2024

(51) Int. Cl. H01Q 1/00; H01Q 1/24; H01Q 1/42

(52) U.S. Cl. CPC H01Q 1/002; H01Q 1/246; H01Q 1/42

(57) ABSTRACT

A base station includes an antenna substrate configured to emit radio waves, a case, and a gasket. The antenna substrate has an antenna formed on a front surface thereof. The case is provided with a window. The antenna is exposed on the outside of the case through the window. The gasket surrounds the window. The front surface of the antenna substrate and an inner surface of the case pinch the gasket. The base station further includes a stiffener on a rear surface of the antenna substrate. The stiffener extends along the gasket.

### TECHNICAL FIELD

The present disclosure relates to an antenna apparatus, in particular, a base station and its use.

### BACKGROUND ART

Patent Literatures 1 to 2 disclose a waterproofed antenna for outdoor use. Patent Literature 1 discloses a manhole cover with an antenna. Patent Literature 2 discloses an integrated antenna apparatus that is not likely to be exposed to rainwater as long as it is kept airtight.

Patent Literature 3 discloses a millimeter wave band planar antenna. In the millimeter wave band planar antenna, a gasket is sandwiched between a dielectric substrate used as an antenna radome and a ground conductor plate with integrated support plates. The gasket surrounds a radiation circuit on the ground conductor plate.

### CITATION LIST

### Patent Literature

Patent Literature 1: Japanese Unexamined Patent Application Publication No. 2015-012504
Patent Literature 2: International Patent Publication No. WO2013/125655
Patent Literature 3: Japanese Unexamined Patent Application Publication No. H10-190351

### SUMMARY OF INVENTION

In the antenna apparatus described in Patent Literatures 1 to 3, while the antenna is made waterproof or airtight, the antenna is not cooled. An object of the present disclosure is to provide an antenna apparatus, in particular, a base station, in which consideration is given to waterproofing and cooling in view of the above-mentioned problems.

A base station includes: an antenna substrate configured to emit radio waves; a case; and a gasket. The antenna substrate has an antenna formed on a front surface thereof. The case has a window. The antenna is exposed on the outside of the case through the window. The gasket surrounds the window. The front surface of the antenna substrate and an inner surface of the case pinch the gasket. The base station further includes a stiffener on a rear surface of the antenna substrate, the stiffener extending along the gasket.

In emitting radio waves using the base station, the radio waves are radiated from the antenna while having the surface of the antenna exposed to the outside air. Heat generated due to emission of the radio waves is released from the surface of the antenna to the outside air.

With the present disclosure, it is possible to provide an antenna apparatus, especially a base station, in which consideration is given to waterproofing and cooling.

### BRIEF DESCRIPTION OF DRAWINGS

FIG. 1 is a cross-sectional diagram of a base station;

FIG. 2 is a three-view diagram of a base station;

FIG. 3 is an exploded diagram of a base station; and

FIG. 4 is a cross-sectional diagram of a base station according to a comparative example.

### EXAMPLE EMBODIMENT

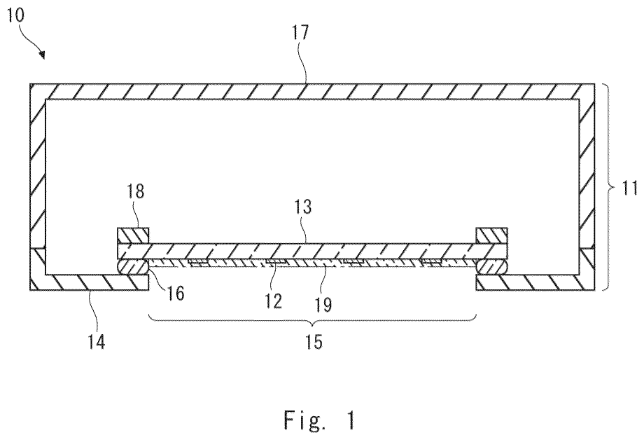

FIG. 1 shows a cross-section of a base station 10. The base station 10 includes a case 11, an antenna substrate 13, and a gasket 16. The case 11 accommodates the antenna substrate 13 and the gasket 16. The case 11 further accommodates components other than the antenna substrate 13 constituting the base station 10. Illustrations of the components are omitted. The base station 10 has communication wiring, power wiring, or terminals for connecting the inside of the case 11 with the outside of the case 11. Illustrations of these wiring and terminals are omitted.

FIG. 1 shows the antenna substrate 13, illustrating a front surface of the antenna substrate on the lower side of the drawing and a rear surface of the antenna substrate on the upper side of the drawing. The antenna substrate 13 has an antenna 12 formed on its front surface. The antenna 12 is a flat antenna, preferably a planar antenna. The front surface of the antenna substrate 13, including the antenna 12, is waterproof-treated.

As one example embodiment of the waterproof treatment of the antenna substrate 13 shown in FIG. 1, the antenna substrate 13 also has a coating 19 covering the surface of the antenna 12. The coating 19 serves to make the antenna 12 waterproof. In one example embodiment, the coating 19 is a coating film. Examples of the material of the coating 19 include fluoropolymer and silicone.

The case 11 shown in FIG. 1 has a window 15. The window 15 is a through hole provided in the case 11. The antenna 12 is exposed on the outside of the case 11 through the window 15. The case 11 includes a box-shaped housing 17 and a cover 14 that serves as a lid for the housing 17. The window 15 is located in the center of the cover 14. The gasket 16 surrounds the window 15. The gasket 16 is annular in one example embodiment.

In the base station 10 shown in FIG. 1, the antenna substrate 13 and the cover 14 are fastened to each other with the gasket 16 interposed therebetween. The front surface of the antenna substrate 13 and the inner surface of the case 11 pinch the gasket 16. In one example embodiment, the gasket 16 is made of an elastomer, such as fluororubber or silicone rubber. The pinched gasket 16 repels and pushes back the front surface of the antenna substrate 13 and the inner surface of the case 11. Accordingly, the gap between the front surface of the antenna substrate 13 and the inner surface of the case 11 is filled. The gasket 16 prevents water and dust from entering the case 11 through this gap.

In the base station 10 shown in FIG. 1, the cross-sectional shape and the overall shape of the gasket 16 before being pinched are appropriately designed. At least one of the front surface of the antenna substrate 13 and the inner surface of the case 11 may have a groove for fitting the gasket 16.

The coating 19 shown in FIG. 1 covers at least a part of the front surface of the antenna substrate 13 that is surrounded by the gasket 16. The gasket 16 and the coating 19 serve to make the front of the antenna substrate 13 waterproof. In a preferred example embodiment, the coating 19 covers at least a part of the front surface of the antenna substrate 13 that is surrounded by the gasket 16. In a preferred example embodiment, the gasket 16 is brought in contact with the coating 19.

The base station 10 shown in FIG. 1 further includes a stiffener 18 on the rear surface of the antenna substrate 13. In one example embodiment shown in the figure, the stiffener 18 is formed separate from the antenna substrate 13. In another example embodiment, the stiffener 18 is integrally formed with the antenna substrate 13. In one example embodiment, the stiffener 18 has a rail shape or other shape. The stiffener 18 extends along the gasket 16. In one example embodiment, the stiffener 18 is annular. In one example embodiment, the stiffener 18 is made of an insulating material.

The gasket 16 shown in FIG. 1 serves to make the interior of the case 11 waterproof. Here, the antenna substrate 13 is deformed by the repulsion of the gasket 16. Therefore, warpage is generated to the antenna substrate 13. The warpage of the antenna substrate 13 impairs the waterproofing property. This is because the antenna substrate 13 cannot sufficiently crush the gasket 16.

The stiffener 18 shown in FIG. 1 reinforces the rear surface of the antenna substrate 13 to suppress the warpage of the antenna substrate 13. The stiffener 18 helps the front surface of the antenna substrate 13 to crush the gasket 16 uniformly and sufficiently. The stiffener 18 prevents water from entering the case 11 from any point on the gasket 16.

In another respect, the deformation of the antenna substrate 13 shown in FIG. 1 may lead to a failure of the components mounted on the antenna substrate 13. The stiffener 18 also helps to prevent the failure of these components by suppressing the deformation of the antenna substrate 13.

In the case 11 shown in FIG. 1, the gap between the cover 14 and the housing 17 are made waterproof. The case 11 is opened by separating the cover 14 and the housing 17 in one example embodiment. Maintenance of the rear surface of the antenna substrate 13 inside the case 11 can be performed by opening the case 11. In addition, maintenance of the components other than the antenna substrate 13 can be performed. When the cover 14 and the housing 17 are joined again, the gap between the cover 14 and the housing 17 is made waterproof again. Waterproof treatment may be performed by installing the gasket between the cover 14 and the housing 17.

The base station 10 shown in FIG. 1 is used as follows. Radio waves are emitted to the antenna 12 while having the surface of the antenna 12 exposed to the outside air. The heat generated due to emission of radio waves is released from the surface of the antenna 12 to the outside air. In a preferred example embodiment, the antenna 12 emits its own heat to the outside of the case 11 through the coating 19.

The base station 10 shown in FIG. 1 is attached to a structure built on land. Examples of structures are buildings, columns, towers, tunnels, and basements. In other example embodiments, the base station 10 is attached to objects that travel on land, on water, or through the air. The objects that travel are manned or unmanned. Examples of objects that travel are automobiles, airships, and ships.

The base station 10 shown in FIG. 1 is installed outdoors where it may rain or snow. In other example embodiments, the base station 10 is installed indoors where splashing or generation of water droplets can occur. In these cases, water enters the housing 17 from between the antenna substrate 13 and the cover 14. The gasket 16 prevents water from entering inside the housing 17 as described above.

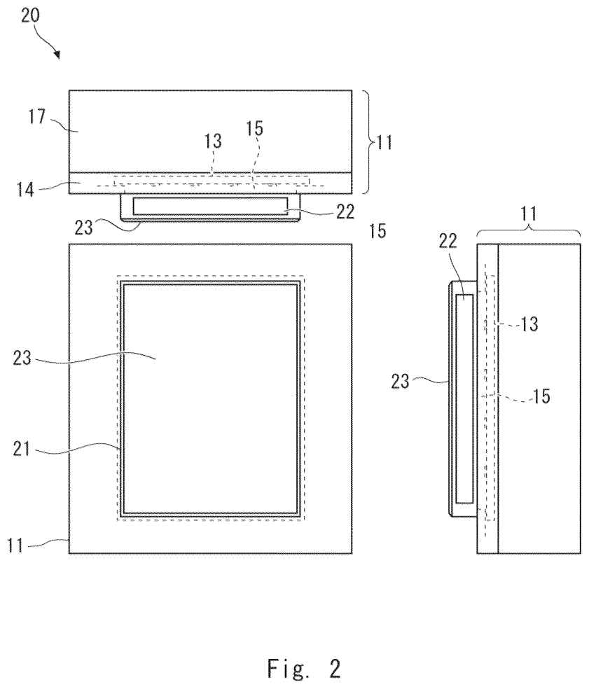

FIG. 2 shows a three-view diagram of a base station 20, which is an example embodiment of the base station 10 shown in FIG. 1. The bottom left is a front view, the top of the front view is a plan view, and the right of the front view is a left side view. The base station 20 is different from the base station 10 shown in FIG. 1 in that it includes a radome 21. The radome 21 is fixed to the front surface of the cover 14. The radome 21 covers the window 15. The radome 21 is made of an insulating material, for example, resin. The radome 21 has a duct 22 and a top part 23.

In the radome 21 shown in FIG. 2, the duct 22 is provided around the top part 23, in other words, at the base part of the radome 21. The duct 22 is open just enough for raindrops to pass through. The diameter of raindrops is said to be approximately 0.2 to 6 mm. The radome 21 has at least one duct 22. Outside air enters through the duct 22 and the window 15 to the front surface of the antenna substrate 13. The antenna on the antenna substrate 13 makes direct contact with the outside air through the duct 22 of the radome 21. Preferably, two or more ducts 22 are provided. The outside air in the radome 21 circulates as the outside air passes from one duct 22 toward the other duct 22.

In the radome 21 shown in FIG. 2, the top part 23 faces the front surface of the antenna substrate 13 through the window 15. The top part 23 protects antenna on the antenna substrate 13 from flying objects, for example. The radome 21 may be removed from the base station 20 if necessary. In the case where the antenna substrate does not have to be protected from the external environment, the base station 10 without a radome is also useful, as shown in FIG. 1.

The radome 21 shown in FIG. 2 may be integrally molded with the cover 14. The shape of the radome 21, the shape of the cover 14, and the shape of the housing 17 are variously designed to suit the performance required of a base station and the location of the base station.

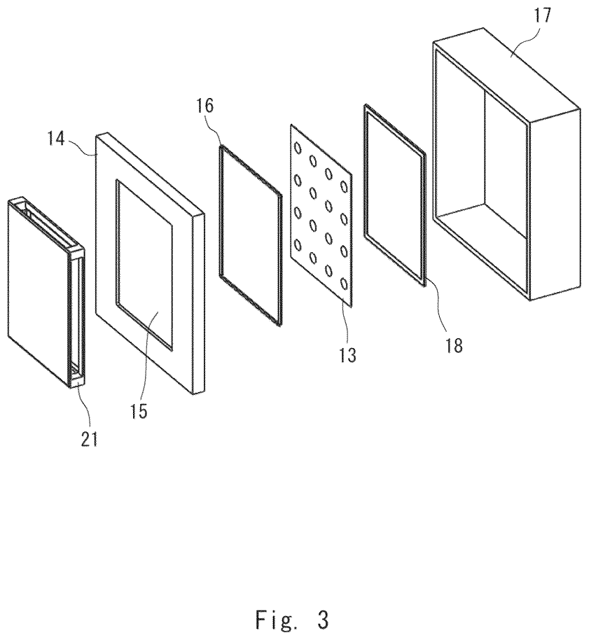

FIG. 3 shows an exploded view of the base station 20. The left-hand side in the figure is the front surface side. The antenna substrate 13 is fixed around the window 15 from the inside of the cover 14. When the antenna substrate 13 is fixed to the cover 14, the gasket 16 is sandwiched between them. The antenna substrate 13 is fixed to the inside of the cover 14 by pressing the stiffener 18 against the rear surface of the antenna substrate 13. As explained by referring to FIG. 1, the stiffener 18 extends along the gasket 16. The antenna substrate 13 with the stiffener 18 pre-attached thereto may be pressed against the gasket 16. Finally, the cover 14 is attached to the housing 17 to keep the inside of the housing 17 airtight. Further, the radome 21 is attached to the cover 14.

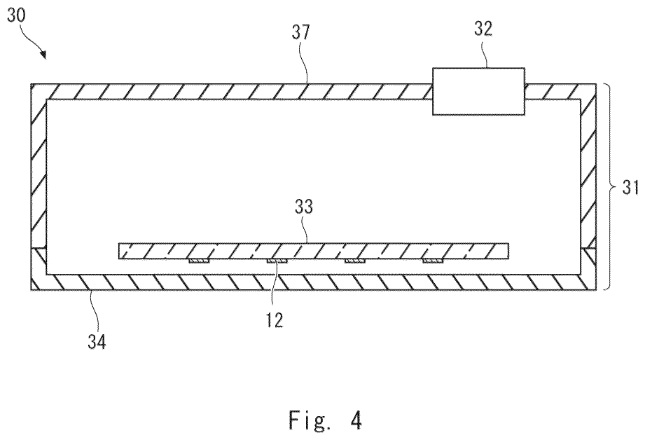

FIG. 4 shows a cross section of a base station 30 according to a comparative example. The base station 30 includes a case 31 and an antenna substrate 33. The antenna 12 is formed on the front surface of the antenna substrate 33. The case 31 includes a housing 37 and a radome 34 for covering the housing 37. The housing 37 has a natural air cooling apparatus 32. The radome 34 is made of resin and includes a radio wave emission surface. The radome 34 protects the antenna substrate 33 and serves to make the housing 37 waterproof. The resin of the radome 34 includes low thermal conductivity. Therefore, the radome 34 does not release the heat generated by the antenna 12 to the outside of the case 31.

The base station 10 shown in FIG. 1 has the antenna 12 that is exposed through the window 15. Therefore, the base station 10 shown in FIG. 1 has a cooling efficiency of the antenna higher than that of the base station 30 shown in FIG. 4. Therefore, the base station 10 shown in FIG. 1 is advantageous in providing a smaller and lighter base station than the base station 30 shown in FIG. 4.

In the base station 30 shown in FIG. 4, heat emitted from the radome 34 to the antenna 12 can be radiated. In this case, the material of the radome 34 can be changed to a material having good thermal conductivity, that is, a conductor. However, the conductor impairs radio wave emission of the antenna 12. In contrast, the base station 10 shown in FIG. 1 does not have a radome. Therefore, the radio emission property of the antenna 12 is not impaired. The base station 20 shown in FIG. 2 has the radome 21 made of an insulating material. Therefore, the radome 21 does not impair the radio emission property of the antenna 12.

In the base station 30 shown in FIG. 4, the natural air cooling apparatus 32 or other heat exhausting apparatuses are essential for removing heat generated by the antenna 12. In contrast, in the base station 10 shown in FIG. 1, outside air removes the heat generated by the antenna 12 is removed by the outside air through the window 15. Therefore, it is not essential to provide a special heat exhausting apparatus in the base station 10. It can be said that the base station 10 has a simpler structure than the base station 30 shown in FIG. 4. On the other hand, heat generated by the antenna 12 may be more efficiently removed by further attaching natural air cooling apparatus or other heat exhausting apparatus to the base station 10.

In the base station 30 shown in FIG. 4, the natural air cooling apparatus 32 removes heat generated from inside the base station 30 other than the heat generated by the antenna 12. Similarly, heat generated from inside the base station 10 other than heat generated by the antenna 12 is removed by installing a natural air cooling apparatus or other heat exhausting apparatuses to the base station 10 shown in FIG. 1. However, the heat exhausting apparatus required for the base station 10 shown in FIG. 1 may be smaller and have lower heat exhausting capacity than the natural air cooling apparatus 32 of the base station 30 shown in FIG. 4. This is because in the base station 10 shown in FIG. 1, the removal of heat generated by the antenna 12 is borne by the window 15.

In the base station 10 shown in FIG. 1, the front surface of the antenna substrate 13 is exposed to the window 15 side. Therefore, more space can be secured in the case 11. Parts and wiring arranged in the case 11 can be arranged more freely.

Some or all of the above-mentioned example embodiment may be described as in the following supplementary notes, but not limited to the following.

### Supplementary Note 1

A base station comprising:
an antenna substrate configured to emit radio waves;
a case; and
a gasket, wherein
the antenna substrate has an antenna formed on a front surface thereof,
the case has a window,
the antenna is exposed on the outside of the case through the window,
the gasket surrounds the window, and
the front surface of the antenna substrate and the inner surface of the case pinch the gasket,
the base station further comprising a stiffener on a rear surface of the antenna substrate, the stiffener extending along the gasket.

### Supplementary Note 2

The base station described in Supplementary Note 1, wherein
the antenna substrate has a coating formed on a front surface thereof, and
the coating serves to make the front surface of the antenna substrate, including the surface of the antenna, waterproof.

### Supplementary Note 3

The base station described in Supplementary Note 1 or 2, further comprising a radome made of an insulating material and covering the window, wherein
the radome has a duct in a base part thereof, and
a top part of the radome is opposed to the front surface of antenna substrate.

### Supplementary Note 4

The base station described in any one of Supplementary Notes 1 to 3, wherein the stiffener is integrally formed with the antenna substrate or is formed separate from the antenna substrate.

### Supplementary Note 5

The base station described in any one of Supplementary Notes 1 to 4, wherein
the case includes a box-shaped housing and a cover that serves as a lid for the housing, and
the cover is provided with the window.

### Supplementary Note 6

Use of the base station described in any one of Supplementary Notes 1 to 5, wherein the radio waves are emitted from the antenna while having the surface of the antenna exposed to the outside air, whereby heat generated due to emission of the radio waves is released from the surface of antenna to the outside air.

### Supplementary Note 7

An antenna apparatus comprising:
an antenna substrate configured to emit radio waves;
a case; and
a gasket, wherein
the antenna substrate has an antenna formed on a front surface thereof,
the case is provided with a window,
the antenna is exposed on the outside of the case through the window,
the gasket surrounds the window, and
the front surface of the antenna substrate and an inner surface of the case pinch the gasket,
the base station further comprising a stiffener on a rear surface of the antenna substrate, the stiffener extending along the gasket.

The present disclosure includes been described above with reference to the example embodiments, but the present disclosure is not limited by the foregoing.

Various changes in the structure and details of the present disclosure can be made within the scope of the present disclosure that can be understood by a person skilled in the art.

### REFERENCE SIGNS LIST

10 BASE STATION, 11 CASE, 12 ANTENNA, 13 ANTENNA SUBSTRATE, 14 COVER, 15 WINDOW, 16 GASKET, 17 HOUSING, 18 STIFFENER, 19 COATING, 20 BASE STATION, 21 RADOME, 22 DUCT, 23 TOP PART, 30 BASE STATION, 31 CASE, 32 NATURAL AIR COOLING APPARATUS, 33 ANTENNA SUBSTRATE, 34 RADOME, 37 HOUSING

What is claimed is:

1. A base station comprising:
an antenna substrate configured to emit radio waves;
a case; and
a gasket, wherein
the antenna substrate has an antenna formed on a front surface thereof,
the case is provided with a window,
the antenna is exposed on the outside of the case through the window,
the gasket surrounds the window, and
the front surface of the antenna substrate and an inner surface of the case pinch the gasket,
the base station further comprising a stiffener on a rear surface of the antenna substrate, the stiffener extending along the gasket.

2. The base station according to claim 1, wherein
the antenna substrate has a coating formed on a front surface thereof, and
the coating serves to make the front surface of the antenna substrate, including the surface of the antenna, waterproof.

3. The base station according to claim 1, further comprising a radome made of an insulating material and covering the window, wherein
the radome has a duct in a base part thereof, and
a top part of the radome is opposed to the front surface of antenna substrate.

4. The base station according to claim 1, wherein the stiffener is integrally formed with the antenna substrate or is formed separate from the antenna substrate.

5. The base station according to claim 1, wherein
the case includes a box-shaped housing and a cover that serves as a lid for the housing, and
the cover is provided with the window.

6. A method for emitting radio waves using the base station as claimed in claim 1, comprising emitting the radio waves from the antenna while having the surface of the antenna exposed to the outside air, whereby heat generated due to emission of the radio waves is released from the surface of the antenna to the outside air.
